(19) United States
(12) Patent Application Publication
(10) Pub. No.: US 2015/0260125 A1
(43) Pub. Date: Sep. 17, 2015

(54) SYNCHRONIZATION SYSTEM FOR A THRUST REVERSER

(71) Applicant: AIRCELLE, GONFREVILLE L'ORCHER (FR)

(72) Inventor: Vincent PEYRON, Le havre (FR)

(21) Appl. No.: 14/716,908

(22) Filed: May 20, 2015

Related U.S. Application Data
(63) Continuation of application No. PCT/FR2013/053013, filed on Dec. 10, 2013.

(30) Foreign Application Priority Data
Dec. 11, 2012 (FR) 12/61854

(51) Int. Cl. F02K 1/56; F02K 1/76

(52) U.S. Cl. CPC F02K 1/56; F02K 1/763

(57) ABSTRACT

The present disclosure provides a thrust reverser device for a turbojet engine nacelle which includes at least two cowls each mounted with the ability to move translationally with respect to a fixed structure between an upstream closed position and a downstream open position. In the upstream position, the two cowls provide aerodynamic continuity of the nacelle, and in the downstream open position, they open a passage in the nacelle. The thrust reverser device further includes at least one synchronization cable extended between the two mobile cowls so as to have a first end attached to an upstream point of one of the two cowls, and a second end attached to a downstream point of the another cowl. In particular, the upstream and downstream attachment points are determined relative to a fixed central zone where the cable passes between the two cowls.

### CROSS-REFERENCE TO RELATED APPLICATIONS

This application is a continuation of International Application No. PCT/FR2013/053013, filed on Dec. 10, 2013, which claims the benefit of FR 12/61854, filed on Dec. 11, 2012. The disclosures of the above applications are incorporated herein by reference.

### FIELD

The present disclosure relates to the field of thrust reversers for aircraft nacelles.

### BACKGROUND

The statements in this section merely provide background information related to the present disclosure and may not constitute prior art.

An aircraft is moved by several turbojet engines each housed in a nacelle also accommodating an assembly of additional actuating devices connected to its operation and providing various functions when the turbojet engine is in operation or at shutdown. These additional actuating devices comprise in particular a thrust reverser device.

A nacelle generally has a tubular structure comprising an air inlet upstream of the turbojet engine, a middle section intended to surround a fan of the turbojet engine, a downstream section intended to surround the combustion chamber of the turbojet engine and possibly integrating the thrust reverser device, and is generally terminated by an ejection nozzle, the outlet of which is situated downstream of the turbojet engine.

The propulsion assembly constituted by the nacelle and the turbojet engine is hooked to a fixed structure of the aircraft, such as a wing or a portion of a fuselage, by a hooking or suspension pylon or mast.

Modern nacelles are intended to accommodate a bypass turbojet engine capable of generating via the blades of the rotating fan a hot air flow (also called primary flow) originating from the combustion chamber of the turbojet engine, and a cold air flow (secondary flow) which circulates outside the turbojet engine through an annular passage, also called flow path, formed between a fairing of the turbojet engine and an inner wall of the nacelle. The two air flows are ejected from the turbojet engine from the rear of the nacelle.

A nacelle generally comprises an outer structure, called Outer Fixed Structure (OFS), which defines, with an inner concentric structure of the rear section, called Inner Fixed Structure (IFS), surrounding the structure of the turbojet engine itself at the rear of the fan, an annular flowing channel, also called secondary flow path, aiming to channel a cold air flow, called secondary air flow, which circulates outside the turbojet engine.

The role of a thrust reverser during the landing of an aircraft is to improve the braking capacity of the latter by redirecting forward at least a part of the thrust generated by the turbojet engine. In this phase, the thrust reverser obstructs the flow path of cold flow and directs it to the front of the nacelle, thereby generating a counter-thrust which is adds to the braking of the wheels of the aircraft.

The means implemented to achieve this reorientation of the cold flow vary depending on the thrust reverser type. However, in all cases, the structure of a thrust reverser comprises movable cowls displaceable between, on the one hand, a deployed position wherein they open a passage in the nacelle intended for the diverted flow, and on the other hand, a retracted position wherein they close this passage. These cowls may fulfill a function of deflection or simply activation of other diverting means.

In the case of a thrust reverser with cascades, also known under the name of cascade-type thrust reverser, the reorientation of the air flow is carried out by cascades vanes, the cowl having only but a simple sliding function aiming to uncover or cover these cascades. Additional blocking doors, also called flaps, activated by the sliding of the cowling, generally allow closing of the flow path downstream of the cascades so as to optimize the reorientation of the cold flow.

In known manner, the cascade vanes are mounted on a front frame serving as a fixed portion of the thrust reverser device and fastened to a casing of the turbojet engine fan. This front frame also provides the support of actuating cylinders of the movable cowls.

Most often, the downstream section of the nacelle is made from two substantially semi-cylindrical half-structures situated, at the upper portion (called 12 hours), on either side of an engine pylon for fastening the turbojet engine to the aircraft and connected together at the lower portion (called 6 hours).

The half-structures are fastened to the engine pylon by means of an upper half-beam, and also comprise a lower half-beam. These lower and upper half-beams are equipped with sliding rails for the thrust reverser movable cowl of the corresponding half-structure.

When the thrust reverser device thus comprises several movable cowls, an important aspect is their synchronization. Indeed, it is important that the cowls move simultaneously and are coordinated precisely. If not, any gap between the movable cowls can lead to phenomena of bracing, or even of blocking of said cowls.

It is known to carry out the synchronization of the movable cowls at the actuators of the latter, in particular in the case of electrical actuators the deployment or retraction position of which can be controlled in a precise manner, in particular thanks to systems of flexible transmission shafts between an electrical motor and its actuators.

This is however more difficult to perform with actuators of pneumatic or hydraulic type.

Currently, the only system allowing to maintain the synchronized cowls is therefore this mechanical synchronization implemented at the actuators. An example of such a system is described in the document WO 2009/147333.

In case of rupture of one of the elements of this actuating system (for example rupture of a cylinder but also of a flexible transmission shaft), the synchronization is no longer provided and the movable cowls can shift several hundred millimeters in particular under the effect of aerodynamic and/or inertial loads, which can drive, as previously mentioned, bracing, blocking or even rupture and breaking of the cowls.

On the existing programs, there are generally two movable cowls (left and right) and three actuators per movable cowl. These cowls are in particular generally stiffer in an axial direction due to thicker aerodynamic lines between the inner and outer lines. This makes these sliding cowls more tolerant to rupture of an element of the actuating system.

Some thrust reverser systems, though, use only two cylinders per movable cowl and the inner and outer aerodynamic lines of the cowls are close together, which greatly reduces their axial stiffness.

Another solution to increase the structural strength of the cowls, and provide their synchronization, is used on thrust reverser devices comprising only but a single substantially peripheral movable cowl, and consists of linking at 12 h, at the mast, the two sides of the sliding cowl by a structural piece crossing from one side to the other the engine pylon. A major drawback of this solution is that when the sliding cowl moves back to get into thrust reversal position, the structural piece also moves back forcing to provide for a large drainage on the engine pylon, which is obviously not optimal for its structural strength.

### SUMMARY

The present disclosure provides a thrust reverser device for a turbojet engine nacelle including at least two cowls each mounted movable in translation with respect to a fixed structure according to a direction substantially parallel to a longitudinal axis of the nacelle between an upstream closed position wherein it provides the aerodynamic continuity of the nacelle, and a downstream open position wherein it opens a passage in the nacelle, characterized in that the thrust reverser device comprises at least one synchronization cable extended between the two movable cowls so as to have a first end fastened to an upstream point of a first cowl, a second end fastened to a downstream point of the second cowl, and the upstream and downstream fastening points being determined with respect to a fixed middle area of the passage of the cable between the two cowls.

Thus, thanks to the extended cable, the second cowl cannot move back further than the first cowl. However, the recoil of the first cowl increases the cable length available for the second cowl and therefore its recoil by the same length. It is the same for the closing of said cowls.

This cable allows obtaining an independent synchronization of the actuators of the thrust reverser and therefore allows overcoming any failure of the latter.

Furthermore, the present disclosure is based on the use of reliable and simple components and does not require significant modifications of the architecture of the sliding cowls. The impact on the mass the assembly is low.

According to one form, the cowls are disposed on either side of a fixed structure at which the middle area of passage of the cable is defined.

In another form, the fixed structure comprises a longitudinal beam. Advantageously, the longitudinal beam is an upper beam called 12 hours.

In another form according to the present disclosure, the fixed structure is part of a structure for hooking to a fastening pylon.

According to an advantageous form, the fixed middle area of the passage of the synchronization cable is defined at least partially using one or more return pulley(s).

In an advantageous manner, the thrust reverser device comprises two crossed synchronization cables.

In still another form, the synchronization cable is maintained in tension using at least one tensioner roller.

Advantageously, the device comprises at least one recoil lock associated with the movable cowl to which the cable is fastened upstream.

The present disclosure also relates to a turbojet engine nacelle comprising such a thrust reverser device.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a simplified representation of the structure of a thrust reverser device according to the present disclosure;

FIG. 2 is a top view according to the axis A-A of FIG. 1 showing a first form of the present disclosure; and

FIG. 3 is a top view according to the axis A-A of FIG. 1 showing a second form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

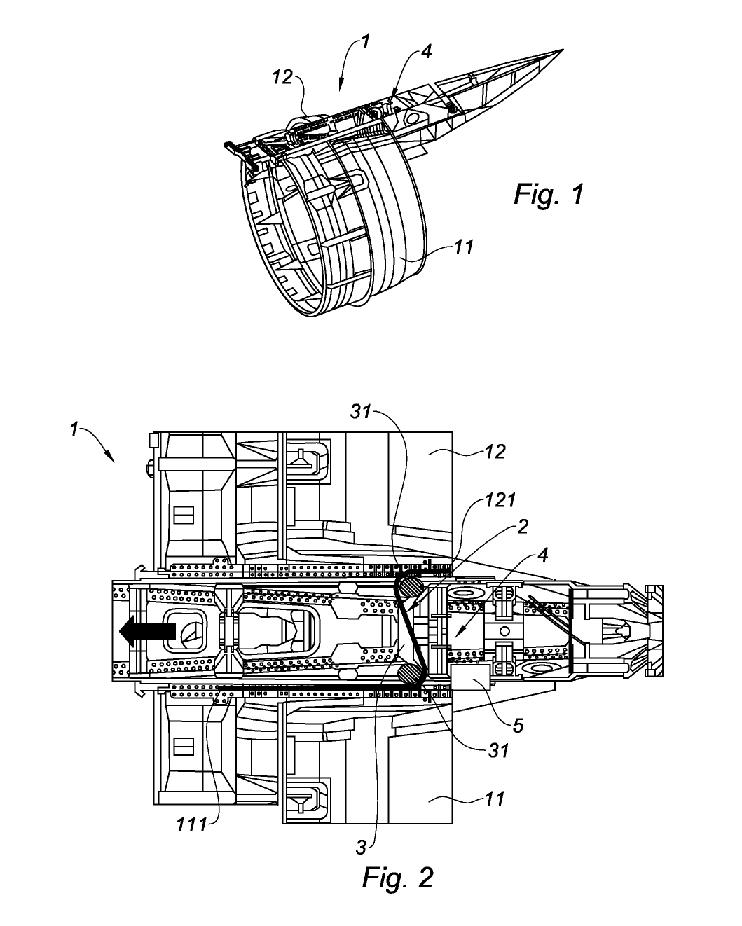

As visible on FIG. 1, a thrust reverser device 1 according to the present disclosure comprises two cowls 11, 12 mounted movable in translation on either side of a structure 4 for hooking to a fastening pylon (not represented).

The present disclosure provides the synchronization of the movements of the movable cowl 11, situated to the left of the hooking structure 4 with respect to the front of the nacelle, and of the movable cowl 12, situated to the right of said hooking structure.

To do this, in accordance with the present disclosure and as visible on FIG. 2, the thrust reverser 1 comprises a synchronization cable 2 extended between the movable cowls 11, 12, said synchronization cable having a first end fastened to an upstream point 111 of the first cowl 11, a second end fastened to a downstream point 121 of the second cowl 12. The upstream 111 and downstream 121 fastening points being determined with respect to a fixed middle area of the passage 3 of the cable 2 between the two cowls 11, 12.

The fixed middle area of the passage 3 of the cable 2 is defined at the hooking structure 4 using return pulleys 31 providing the passage of the cable from the left side to the right side of the hooking structure 4 through the latter.

It should be noted that the left cowl 11 is associated with a recoil lock 5 disposed on the left side of the hooking structure 4 and prohibiting the recoil of said movable cowl. The synchronization cable 2 blocks then naturally the recoil of the right cowl 12.

When the left cowl 11 moves back toward a thrust reversal position, the total cable length is not modified and this one slides through the hooking structure 4.

Thus, a movement of the left cowl 11 reduces the length of the cable 2 available on the left side of the hooking structure 4 and increases the cable 2 length available on the right side. The right fastening point 121 of the cable being situated downstream of the left fastening point 111 of the cable, with respect to the middle area of the passage 3, the supplementary distance of the cable 2 on the right side allows the movement of the right cowl 12 of the same length as the left cowl 11.

In the case where the device comprises only one synchronization cable 2 as described above, the left cowl 11, on the side of the recoil lock 5, constitutes a master cowl, relative to which the synchronization of the right cowl 12 is carried out, constituting a slave cowl.

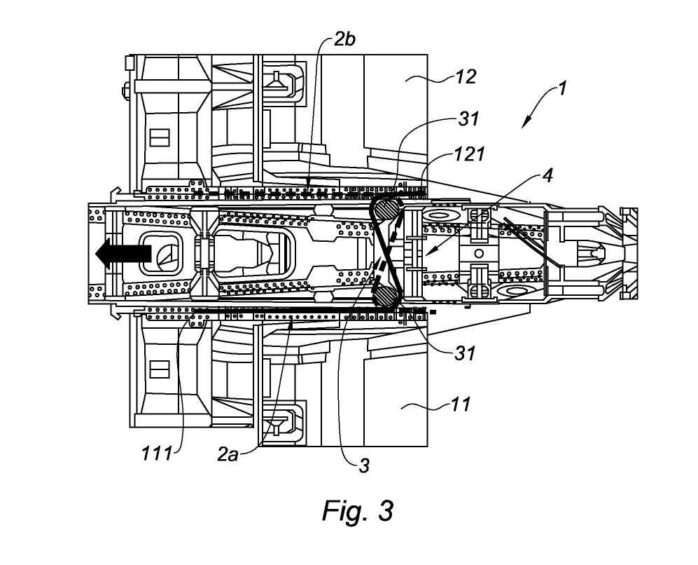

A mutual synchronization can be provided by the setting up of two crossed synchronization cables 2a, 2b as represented on FIG. 3.

In order to limit the vibrations in the synchronization cable 2 during the flight phases, this one may be maintained in tension using a tensioner roller-type system.

Such a tensioner roller system may also allow to authorize a low desynchronization between the two cowls 11, 12 in order to avoid that the system is hyperstatic with respect to the driving cylinders which already control the position of the cowls 11, 12 in the absence of problems. Making the cable 2 work under fatigue is then avoided since this one is only biased when the desynchronization of the cowls 11, 12 exceeds an expected value, this limit value of desynchronization being only reached during the rupture of an element of the driving system of the cowls 11, 12, cylinder or flexible shaft, for example.

It will also be noted that the length of the synchronization cable 2 may be slightly greater than the desired stroke of the movable cowls 11, 12 plus the width of the fixed middle area of the passage 3 (width of the hooking structure 4 in the instant case).

Advantageously, the fastening points 111, 121 of the synchronization cable 2 will be situated on sliding guides of the cowls 11, 12 in order to avoid the addition of new structural pieces. Preferably, these fasteners will be dismountable so as to allow the installation/removal of the cowls 11, 12.

In the case where a tensioner roller system is used, it is possible to equip the roller(s) with switches which are triggered when the cable expands or breaks down.

Although the present disclosure has been described with an exemplary form, it is evident that it is in no way limited and that it comprises all technical equivalents of the described means as well as their combinations if the latter fall within the scope of the present disclosure.

What is claimed is:

1. A thrust reverser device for turbojet engine nacelle including at least two cowls comprising first and second cowls each mounted movable in translation with respect to a front fixed structure in a direction substantially parallel to a longitudinal axis of the nacelle between an upstream closed position wherein said at least two cowls provide an aerodynamic continuity of the nacelle, and a downstream open position wherein said at least two cowls open a passage in the nacelle, wherein the thrust reverser device comprises at least one synchronization cable extended between said at least two cowls so as to have a first end fastened to an upstream point of the first cowl, a second end fastened to a downstream point of the second cowl, and the upstream and downstream fastening points being determined with respect to a fixed middle area of a passage of said at least one synchronization cable between the first and second cowls.

2. The device according to claim 1, wherein said at least two cowls are disposed on either side of a fixed structure at which the middle area of the passage of said at least one synchronization cable is defined.

3. The device according to claim 2, wherein the fixed structure comprises a longitudinal beam.

4. The device according to claim 3, wherein the longitudinal beam is an upper beam called 12 hours beam.

5. The device according to claim 2, wherein the fixed structure is part of a structure for hooking to a fastening pylon.

6. The device according to claim 1, wherein the fixed middle area of the passage of said at least one synchronization cable is defined at least partially using one or more return pulley(s).

7. The device according to claim 1, further comprising two crossed synchronization cables.

8. The device according to claim 1, wherein said at least one synchronization cable is maintained in tension using at least one tensioner roller.

9. The device according to claim 1, further comprising at least one recoil lock associated with the first cowl to which said at least one synchronization cable is fastened upstream.

10. A turbojet engine nacelle comprising at least one thrust reverser device according to claim 1.
